(19) United States
(12) Patent Application Publication
(10) Pub. No.: US 2020/0089229 A1
(43) Pub. Date: Mar. 19, 2020

(54) SYSTEMS AND METHODS FOR USING NONLINEAR MODEL PREDICTIVE CONTROL (MPC) FOR AUTONOMOUS SYSTEMS

(71) Applicant: GM GLOBAL TECHNOLOGY OPERATIONS LLC, Detroit, MI (US)

(72) Inventors: Joonho Lee, Troy, MI (US); Vincent DeSapio, Westlake Village, CA (US)

(73) Assignee: GM GLOBAL TECHNOLOGY OPERATIONS LLC, Detroit, MI (US)

(21) Appl. No.: 16/133,987

(22) Filed: Sep. 18, 2018

(51) Int. Cl. G05D 1/00; G05D 1/02

(52) U.S. Cl. CPC G05D 1/0088; G05D 1/0212

(57) ABSTRACT

A method for using a closed-loop control system to control an autonomous system is disclosed, the closed-loop control system comprising an explicit Nonlinear Model Predictive Control (NMPC) framework. The method (i) computes operation parameters for the autonomous system using the closed-loop control system, the output of the explicit NMPC framework comprising the operation parameters; (ii) modifies the output of the explicit NMPC framework to consider unmeasured system states, unknown system model values, and external disturbances, to create modified operation parameters, using an extended high-gain observer (EHGO) to estimate the unmeasured system states and the external disturbances and a dynamic inverter to compute values of unknown input coefficients for a system model of the autonomous system; (iii) generates a modified output signal including the modified operation parameters; and (iv) transmits the modified output signal to control operation of the autonomous system using the modified operation parameters.

### TECHNICAL FIELD

Embodiments of the subject matter described herein relate generally to the use of explicit Nonlinear Model Predictive Control (NMPC) to control autonomous systems. More particularly, embodiments of the subject matter relate to modifying an explicit NMPC output signal to compensate for modeling uncertainties, thereby improving performance of controlled autonomous systems.

### BACKGROUND

Challenges in controlling autonomous systems include dealing with modeling uncertainty and stability of closed-loop systems. Control designs for nonlinear systems, including mechanical systems, typically include uncertain parameters due to the inability of mathematical descriptions to fully represent the dynamics of systems. For example, system dynamics of ground and aerial vehicles can be modeled with mathematical equations that use approximations of parameter values, instead of known parameter values, resulting in model uncertainties. Unconsidered model uncertainties result in degenerating qualities of system performance.

Accordingly, it is desirable to provide control methods that accommodate modeling uncertainties and potential closed-loop system instability. Furthermore, other desirable features and characteristics will become apparent from the subsequent detailed description and the appended claims, taken in conjunction with the accompanying drawings and the foregoing technical field and background.

### BRIEF SUMMARY

Some embodiments of the present disclosure provide a method for using a closed-loop control system to control an autonomous mechanical system, the closed-loop control system comprising an explicit Nonlinear Model Predictive Control (NMPC) framework. The method (i) computes operation parameters for the autonomous mechanical system using the closed-loop control system comprising the explicit NMPC framework, wherein output of the explicit NMPC framework comprises the operation parameters; (ii) modifies the output of the explicit NMPC framework to consider unmeasured system states, unknown system model values, and external disturbances to the autonomous mechanical system, to create modified operation parameters, by: obtaining measured system states for the autonomous mechanical system, via one or more sensors onboard the autonomous mechanical system; using an extended high-gain observer (EHGO) to estimate the unmeasured system states and the external disturbances based on the measured system states, to generate estimated unmeasured system states and estimated external disturbances; and using a dynamic inverter to compute values of unknown input coefficients for a system model of the autonomous mechanical system, wherein the unknown system model values comprise at least the unknown input coefficients; (iii) generates a modified output signal for the closed-loop control system, the modified output signal comprising the modified operation parameters, based on the estimated unmeasured system states and the estimated external disturbances and the values of the unknown input coefficients; and (iv) transmits the modified output signal of the closed-loop control system, to control operation of the autonomous mechanical system using the modified operation parameters.

Some embodiments of the present disclosure provide a controller device for an autonomous mechanical system. The controller device includes: (1) a system memory element, configured to store and maintain at least a closed-loop control system, an explicit Nonlinear Model Predictive Control (NMPC) framework, and one or more system models for the autonomous mechanical system; (2) a communication device, configured to transmit and receive communications including control instructions and control system feedback for the autonomous mechanical system; and (3) at least one processor, communicatively coupled to the system memory element and the communication device, the at least one processor configured to: compute operation parameters for the autonomous mechanical system using the closed-loop control system comprising the explicit NMPC framework, wherein output of the explicit NMPC framework comprises the operation parameters; modify the output of the explicit NMPC framework to consider unmeasured system states, unknown system model values, and external disturbances to the autonomous mechanical system, to create modified operation parameters, by: obtaining measured system states for the autonomous mechanical system, via one or more sensors onboard the autonomous mechanical system; using an extended high-gain observer (EHGO) to estimate the unmeasured system states and the external disturbances based on the measured system states, to generate estimated unmeasured system states and estimated external disturbances; and using a dynamic inverter to compute values of unknown input coefficients for a system model of the autonomous mechanical system, wherein the unknown system model values comprise at least the unknown input coefficients. The at least one processor is further configured to: generate a modified output signal for the closed-loop control system, the modified output signal comprising the modified operation parameters, based on the estimated unmeasured system states and the estimated external disturbances and the values of the unknown input coefficients; and transmit the modified output signal of the closed-loop control system, to control operation of the autonomous mechanical system using the modified operation parameters.

Some embodiments of the present disclosure provide a non-transitory, computer-readable medium containing instructions thereon, which, when executed by a processor, perform a method for using a closed-loop control system to control an autonomous mechanical system, the closed-loop control system comprising an explicit Nonlinear Model Predictive Control (NMPC) framework. The method: (i) receives one or more control inputs as input parameters for the explicit NMPC framework, via the closed-loop control system for the autonomous mechanical system; (ii) obtains a system model for the autonomous mechanical system, wherein the system model comprises one or more mathematical descriptions of system dynamics of the autonomous mechanical system; (iii) computes operation parameters for the autonomous mechanical system, using the one or more control inputs and the one or more mathematical descriptions, using the closed-loop control system comprising the explicit NMPC framework, wherein output of the explicit NMPC framework comprises the operation parameters; and (iv) modifies the output of the explicit NMPC framework to consider unmeasured system states, unknown system model values, and external disturbances to the autonomous mechanical system, to create modified operation parameters, by: obtaining measured system states for the autonomous mechanical system, via one or more sensors onboard the autonomous mechanical system; using an extended high-gain observer (EHGO) to estimate the unmeasured system states and the external disturbances based on the measured system states, to generate estimated unmeasured system states and estimated external disturbances; and using a dynamic inverter to compute values of unknown input coefficients for a system model of the autonomous mechanical system, wherein the unknown system model values comprise at least the unknown input coefficients. The method further: (v) generates a modified output signal for the closed-loop control system, the modified output signal comprising the modified operation parameters, based on the estimated unmeasured system states and the estimated external disturbances and the values of the unknown input coefficients; and (vi) controls operation of the autonomous mechanical system using the modified output signal, by: applying a state vector to a trajectory of the autonomous mechanical system, the state vector comprising the modified operation parameters; adjusting the trajectory, based on the state vector, to generate a corrected trajectory; and operating the autonomous mechanical system using the corrected trajectory.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a system for improving typical performance of an autonomous system, in accordance with the disclosed embodiments;

FIG. 2 is a functional block diagram of a computing device for use in a system for improving typical performance of an autonomous system, in accordance with the disclosed embodiments;

FIG. 3 is a dataflow diagram of a closed-loop control system 300 for improving typical performance of an autonomous system, and which implements explicit Nonlinear Model Predictive Control (NMPC), Extended High-Gain Observers (EHGOs), and dynamic inversion, in accordance with the disclosed embodiments;

FIG. 4 is a diagram of control flow for improving typical performance of an autonomous system, in accordance with the disclosed embodiments;

FIG. 5 is a diagram of an exemplary embodiment of a vehicle model applicable to an autonomous system, in accordance with the disclosed embodiments;

FIG. 6 is a diagram of a control algorithm for an exemplary embodiment of a vehicle model applicable to an autonomous system, in accordance with the disclosed embodiments;

FIG. 7 is a flow chart that illustrates an embodiment of a process for using a closed-loop control system comprising an explicit Nonlinear Model Predictive Control (NMPC) to control an autonomous system, in accordance with the disclosed embodiments;

FIG. 8 is a flow chart that illustrates an embodiment of a process for modifying explicit Nonlinear Model Predictive Control (NMPC) generated operation parameters using an Extended High-Gain Observer (EHGO), in accordance with the disclosed embodiments; and

FIG. 9 is a flow chart that illustrates an embodiment of a process for modifying explicit Nonlinear Model Predictive Control (NMPC) generated operation parameters using dynamic inversion, in accordance with the disclosed embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to systems and methods for operating autonomous systems according to a planned trajectory with increased precision and accuracy. Due to modeling uncertainties and potential instability of closed-loop control systems, autonomous operation of mechanical systems is potentially associated with error or deviation from the planned trajectory. Errors in a system model for an autonomous system result in errors in adhering to a planned trajectory for the autonomous system. Contemplated herein are techniques for accommodating the modeling uncertainties and instability, resulting in mechanical system positioning closer to the planned trajectory, such that performance of autonomous systems is improved over system models that include unknown values. Uncertain input coefficients, unmeasured system states, and external disturbances are critical to system performance because uncertain input directions degenerate system performance and uncertain or unknown values destabilize the system. To accommodate modeling uncertainties and potential instability, a closed-loop control system is implemented, which includes an explicit, Nonlinear Model Predictive Control (NMPC), an Extended High-Gain Observer (EHGO), and a dynamic inverter.

The combination of the three elements in the closed-loop control system uses multiple time scales, wherein the EHGOs operate using a fastest time scale, the dynamic inverters operate using an intermediate time scale, and the explicit NMPC and system models (i.e., system dynamics) operate using a slowest time scale. The speed of operation for each component of the closed-loop control system operates according to a corresponding time scale, and each of the time scales is determined to be fastest, intermediate-speed, and slowest as each of the time scales relates to the other two time scales. The multiple time scale structure of the closed-loop control system is designed using the singular perturbation method in order to combine three methods of performing computations for closed-loop control (e.g., explicit NMPC, EHGOs, dynamic inversion). The combination of the three elements in the closed-loop control system accommodates modeling uncertainties, system disturbances, and potential instability, and thus generates control commands for the autonomous system to adhere more closely to the planned trajectory than a closed-loop control system that includes only the explicit NMPC.

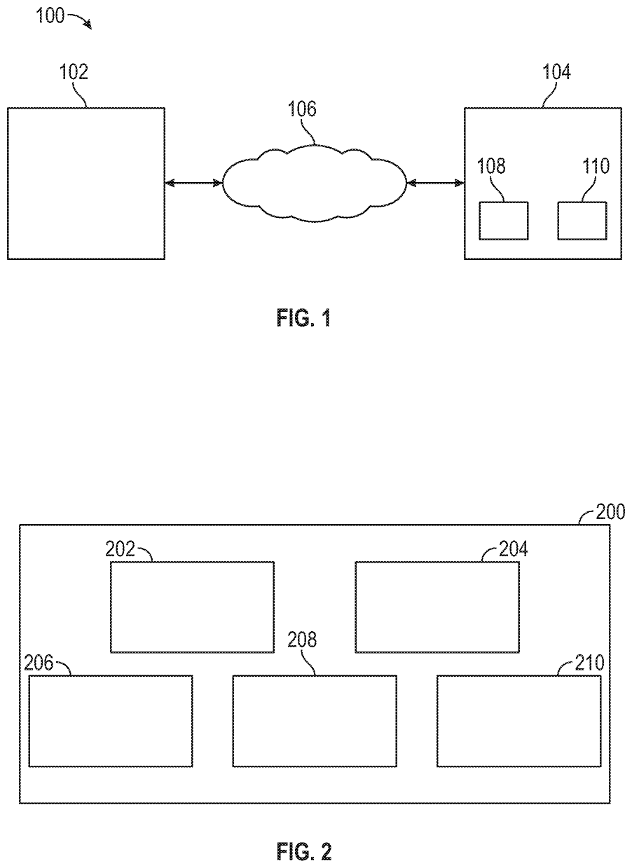

Turning now to the figures, FIG. 1 is a diagram of a system 100 for improving typical performance of an autonomous system 104, in accordance with the disclosed embodiments. The system 100 operates to compute and transmit a closed-loop control system output signal to control the autonomous system 104, wherein the closed-loop control system output signal has been manipulated to improve performance of the autonomous system 104. The system 100 may include, without limitation, a computing device 102 that communicates with a planning module (e.g., the path planning module 108) and an execution module (e.g., the autonomous operation module 110) of the autonomous system 104, via a data communication network 106. In practice, certain embodiments of the system 100 may include additional or alternative elements and components, as desired for the particular application.

The computing device 102 may be implemented by any computing device that includes at least one processor, some form of memory hardware, and communication hardware configured to establish communication connections to the autonomous system 104. For example, the computing device 102 may be implemented using a standalone computer system, a portable computing device, a vehicle-based computing device (e.g., an Electronic Control Unit (ECU) or other vehicle-based controller), or a personal computing device (e.g., a tablet computer, a laptop computer, a personal digital assistant (PDA), a smartphone), or the like. In this scenario, the computing device 102 is capable of storing, maintaining, and executing instructions configured to generate and modify a closed-loop control system output signal that controls the autonomous system, during operation of the autonomous system. Exemplary embodiments of the computing device 102 are typically implemented onboard the autonomous system 104; and the computing device 102 communicates with the autonomous system 104 via wired and/or wireless communication connection.

The autonomous system 104 may be a vehicle (e.g., ground vehicle, aerial vehicle, underwater vehicle), a walking bipedal robot, a prosthetic requiring human body motor control, and/or any type of autonomous mechanical system for which explicit Nonlinear Model Predictive Control (NMPC) design is applicable. The autonomous system 104 typically includes a path planning module 108 and an autonomous operation module 110. The path planning module 108 is configured to obtain, store, and transmit or provide access to a planned trajectory for the autonomous system 104. The autonomous operation module 110 is configured to perform operations of the autonomous system 104 such that the autonomous system 104 follows the planned trajectory. It should be appreciated that, in some embodiments of the system 100, the computing device 102 may be implemented as a device that is separate and distinct from the autonomous system 104. However, in other embodiments of the system 100, the computing device 102 may be implemented as a device that is integrated into the autonomous system 104. For example, the computing device 102 may be an integrated part of the autonomous operation module 110 and/or may be communicatively coupled to the autonomous operation module 110.

The data communication network 106 may be any digital or other communications network capable of transmitting messages or data between devices, systems, or components. Exemplary embodiments of the data communication network 106 may be implemented using a Controller Area Network (CAN), including but not limited to a CAN data communication bus and one or more devices or components of the autonomous system 104 that are connected to the CAN bus. In certain embodiments, the data communication network 106 includes a packet switched network that facilitates packet-based data communication, addressing, and data routing. The packet switched network could be, for example, a wide area network, the Internet, or the like. In various embodiments, the data communication network 106 includes any number of public or private data connections, links or network connections supporting any number of communications protocols. The data communication network 106 may include the Internet, for example, or any other network based upon TCP/IP or other conventional protocols. In various embodiments, the data communication network 106 could also incorporate a wireless and/or wired telephone network, such as a cellular communications network for communicating with mobile phones, personal digital assistants, and/or the like. The data communication network 106 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

During typical operation, the computing device 102 implements a closed-loop control system for controlling the autonomous system 104, wherein the closed-loop control system includes an explicit Nonlinear Model Predictive Control (NMPC). In this way, the computing device 102 obtains control data (e.g., one or more control inputs, a planned trajectory for the autonomous system 104, a system model of the autonomous system 104) for the autonomous system 104, and then provides the control data as input values to the explicit NMPC framework. The explicit NMPC framework uses the control data to generate “typical” operation parameters for the autonomous system 104, including control commands for autonomous operation of the autonomous system 104 based on the planned trajectory. The computing device 102 then modifies the typical operation parameters produced by the explicit NMPC framework to compensate for unmeasured system states, unknown system model values, and external disturbances to the autonomous system 104. To perform the modification of the typical parameters, the computing device 102 uses an Extended High-Gain Observer (EHGO) and a dynamic inverter, which have been incorporated into the closed-loop control system. Using the EHGO and the dynamic inverter, the modified closed-loop control system is capable of estimating unknown system states and external disturbances, and is further capable of computing values of unknown input coefficients of the system model. Thus, the closed-loop control system (and the computing device 102 implementing such) is configured to accommodate uncertainties in the system model by computing modified operation parameters and modified or corrected trajectory values for the autonomous system 104.

FIG. 2 is a functional block diagram of a computing device 200 for use in a system for improving typical performance of an autonomous system, in accordance with the disclosed embodiments. It should be noted that the computing device 200 can be implemented with the computing device 102 depicted in FIG. 1. In this regard, the computing device 200 shows certain elements and components of the computing device 102 in more detail.

The computing device 200 generally includes, without limitation: at least one processor 202; system memory 204; a communication device 206; a closed-loop control system module 208; and an autonomous mechanical system control module 210. These elements and features of the computing device 200 may be operatively associated with one another, coupled to one another, or otherwise configured to cooperate with one another as needed to support the desired functionality—in particular, generating and optimizing closed-loop control commands for an autonomous mechanical system, as described herein. For ease of illustration and clarity, the various physical, electrical, and logical couplings and interconnections for these elements and features are not depicted in FIG. 2. Moreover, it should be appreciated that embodiments of the computing device 200 may include other elements, modules, and features that cooperate to support the desired functionality. For simplicity, FIG. 2 only depicts certain elements that relate to the closed-loop control techniques for the autonomous mechanical system, described in more detail below.

The at least one processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 is communicatively coupled to the system memory 204. The system memory 204 is configured to store any obtained or generated data associated with closed-loop control systems, autonomous system trajectories, control commands, modified control commands, explicit Nonlinear Model Predictive Control (NMPC), Extended High-Gain Observers (EHGOs), dynamic inversion, or the like. The system memory 204 may be realized using any number of devices, components, or modules, as appropriate to the embodiment. Moreover, the computing device 200 could include system memory 204 integrated therein and/or a system memory 204 operatively coupled thereto, as appropriate to the particular embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the computing device 200. The system memory 204 can be coupled to the at least one processor 202 such that the at least one processor 202 can read information from, and write information to, the system memory 204. In the alternative, the system memory 204 may be integral to the at least one processor 202. As an example, the at least one processor 202 and the system memory 204 may reside in a suitably designed application-specific integrated circuit (ASIC).

The communication device 206 is suitably configured to communicate data between the computing device 200 and an autonomous system, for purposes of operating the autonomous system according to modified control outputs (produced by the autonomous system control module 216). In some embodiments, the communication device 206 may transmit and receive communications over a vehicle-based communication network, such as a Controller Area Network (CAN), which includes a data communication bus (e.g., a CAN bus) and other devices or components onboard the autonomous system. In other embodiments, the communication device 206 may transmit and receive communications over a wireless local area network (WLAN), the Internet, a satellite uplink/downlink, a cellular network, a broadband network, a wide area network, or the like. As described in more detail below, data received by the communication device 206 may include, without limitation: a planned trajectory for the autonomous system, a system model for the autonomous system, one or more additional control inputs for the autonomous system, and other data compatible with the computing device 200. Data provided by the communication device 206 may include, without limitation: control commands for the autonomous system, modified control commands for the autonomous system, and the like.

The closed-loop control system module 208 is configured to provide a closed-loop control system framework for use in controlling a communicatively coupled autonomous system. Closed-loop systems use a portion of a produced output signal as feedback to the input of the closed-loop system, for purposes of reducing errors and improving stability. A closed-loop control system uses an open-loop system as a forward path, but also includes one or more feedback loops or paths between the closed-loop control system output and the closed-loop control system input.

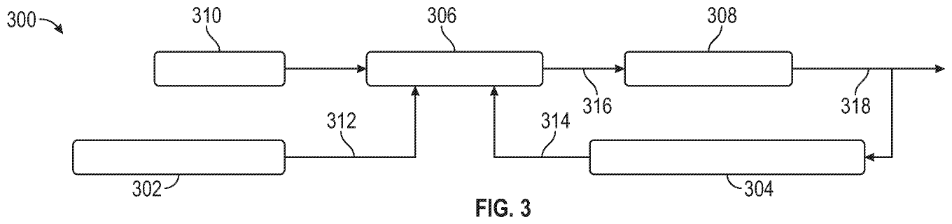

An exemplary embodiment of the closed-loop control system provided by the closed-loop control system module 208 is illustrated below with regard to FIG. 3. As shown, FIG. 3 is a dataflow diagram of a closed-loop control system 300 for improving typical performance of an autonomous system, and which implements explicit Nonlinear Model Predictive Control (NMPC), Extended High-Gain Observers (EHGOs), and dynamic inversion, in accordance with the disclosed embodiments. It should be appreciated that the closed-loop control system 300 may be one exemplary implementation of the closed-loop control system framework implemented by the computing device 102 used to improve typical performance of an autonomous system 104, as shown in FIG. 1. As described herein, the closed-loop control system 300 uses an open-loop system as a forward path, and also includes a feedback loop to use a portion of the produced output signal as feedback to the input of the closed-loop control system 300, to reduce errors and improve stability.

The closed-loop control system 300 receives input, including: an output signal from an explicit Nonlinear Model Predictive Control (NMPC) 302 and a reference load 310 associated with trajectory planning for the autonomous system. The closed-loop control system 300 includes the explicit NMPC 302, an Extended High-Gain Observer (EHGO) 304, a dynamic inverter 306, and system dynamics 308 associated with the autonomous system.

The explicit NMPC 302 is configured to provide an explicit NMPC framework and functionality as part of the closed-loop control system 300. Model Predictive Control (MPC) provides functionality for a controller (e.g., the computing device 200 of FIG. 2) to operate a communicatively coupled autonomous mechanical system in optimal conditions, using constraints that include system states and system inputs based on system models. Linear MPCs use long-range generalized predictive control, including polynomials to linearize outputs. Nonlinear MPCs (NMPCs) are an extension of linear MPCs, but require a resource-intensive computation to perform on-line, convex optimization. Further, stability of NMPCs is addressed using a dual-mode control approach, wherein a receding horizon control is used outside of the terminal region, and when the states reach the boundary of the terminal region, a quasi-infinite horizon, NMPC scheme is used, including an on-line objective function composed of a finite horizon cost and a terminal cost. By employing the cost function, the terminal function bounds the infinite horizon cost of the nonlinear system and stability is achieved. The explicit NMPC 302 framework approximates the outputs of continuous-time systems using Taylor series with the number of relative degrees and input derivatives.

The explicit NMPC 302 determines a solution explicitly, thereby reducing an excessively intensive computation burden that is typical for NMPCs and ensuring stability of the closed-loop control system 300. However, the explicit NMPC 302 does not consider imperfections and unknown values associated with the system model, including unmeasured system states, system model uncertainties, unknown input coefficients, system disturbances, and the like. As described herein, the explicit NMPC 302 is further configured to provide output to the dynamic inverter 306 and, indirectly, to the EHGO 304, which modify the explicit NMPC generated output to compensate for the aforementioned unknown values and imperfections in the system model.

As shown, the explicit NMPC 302 provides a framework to compute and provide optimal gains 312 for the autonomous system. As it relates to the closed-loop control system 300, the explicit Nonlinear Model Predictive Control (NMPC) 302 provides a frame for the control design architecture. For example, dynamic inverter 306 can be designed in a different way to overcome certain coefficients. By using the explicit NMPC 302, the dynamic inverter 306 is designed to satisfy the criteria provided by the explicit NMPC 302.

Input values to the explicit NMPC 302 include a system model for the autonomous system, and historical control move data associated with the autonomous system. Using the system model and the historical control move data, the explicit NMPC 302 computes optimal gains 312 for the autonomous system. The mathematical ratio of the output of a particular device to its input represents its gain, and this gain describes the behavior of the system. Here, the explicit NMPC 302 provides optimal gains 312 for the autonomous system to ensure optimal conditions to be used in calculations for the autonomous system in the closed-loop control system 300. When the gain of the closed-loop control system 300 is too sensitive to changes in input commands or signals, the closed-loop control system 300 can become unstable and begin to oscillate as the closed-loop control system 300 attempts to over-correct, potentially resulting in an error condition. An optimized gain provides pre-defined and optimized limits for the closed-loop control system 300, thus improving behavior of the closed-loop control system 300. The explicit NMPC 302 provides the optimal gains 312 to the dynamic inverter of the closed-loop control system 300.

The Extended High-Gain Observer (EHGO) 304 is configured to estimate unmeasured system states, uncertain system models, and external disturbances using the output 318 of the closed-loop control system 300. As shown, the EHGO 304 provides estimated values 314 for system uncertainties (e.g., unmeasured system states, external disturbances), to improve computation of operation parameters of the autonomous system. The EHGO 304 uses input values including (i) measurements received from sensors onboard the autonomous system, and (ii) the system model associated with the autonomous system. As described previously, the EHGO 304 is a type of “observer” or a system that provides an estimate of the internal state of the autonomous system, from measurements of the input and output of the autonomous system. As described herein, the system is modeled using Ordinary Differential Equations (ODE), and the EHGO 304 estimates values 314 for the system uncertainties using ODE and the input measured values according to the system model. The EHGO 304 provides the estimated values 314 to the dynamic inverter 306 of the closed-loop control system 300, for further modification of explicit NMPC output parameters used to control the autonomous system that is communicatively coupled to the closed-loop control system 300.

The reference load 310 is associated with trajectory planning for the autonomous system, and provides desired trajectory data for the autonomous system. The desired trajectory data (i.e., a planned trajectory) is predefined and stored for use by the closed-loop control system 300 to operate the autonomous system. The autonomous system includes a planning module and a control module, wherein the planning module provides a reference trajectory that includes reference positions, reference velocities, and reference accelerations for the planned trajectory of the autonomous system. The reference load 310 block includes and provides the planned trajectory data to the dynamic inverter 306 of the closed-loop control system 300.

The dynamic inverter 306 is configured to determine unknown input coefficient values associated with the system model of the autonomous system communicatively coupled to, and controlled by, the closed-loop control system 300. System models of the autonomous system comprise mathematical descriptions of the system dynamics 308. The autonomous system may be modeled using various control algorithms which include Ordinary Differential Equations (ODE). As shown, the dynamic inverter 306 provides estimations for any unknown input coefficients of the ODE used in the system model, to improve computation of operation parameters of the autonomous system. The dynamic inverter 306 receives input values including (i) the estimated values 314 provided by the EHGO 304, and (ii) the optimal gains 312 provided by the explicit NMPC 302. Dynamic inversion may also be referred to as feedback linearization, which is a control approach used for nonlinear systems, and involves using a transformation of the nonlinear system into an equivalent linear system through a change of variables and a suitable control input. As described herein, the system is modeled using Ordinary Differential Equations (ODE), and the dynamic inverter 306 estimates unknown input coefficients of the ODE for the estimated values 314, the optimal gains 312, and the planned trajectory provided by the reference load 310. The dynamic inverter 306 generates a control signal 316 for use by the system dynamics 308 to compute operation parameters for the autonomous system. The dynamic inverter 306 operates in conjunction with the explicit NMPC 302 to estimate the unknown values used to perform computations in a control algorithm for the autonomous system, thus providing increased accuracy of performance of the autonomous mechanical system.

The system dynamics 308 is the system model of the autonomous system, which includes mathematical relationships (described using ODE) for the operations that are performed by the autonomous mechanical system. The system dynamics 308 obtains control inputs to the autonomous system (e.g., the control signal provided by the dynamic inverter 306), performs computations using the control inputs, and provides an output signal 318 to the autonomous system, which includes operation parameters for use by the autonomous system. The operation parameters provided by the closed-loop control system 300 may include any calculated system dynamic value that may be controlled via the output signal 318. For example, when the autonomous system is implemented as an autonomous vehicle, the operation parameters may include a torque value for the wheels as a control input, a vehicle speed value, a vehicle heading, or a vehicle acceleration value.

The closed-loop control system 300 generates the output signal 318 that is transmitted or otherwise provided to the communicatively coupled autonomous system. In some embodiments, the closed-loop control system 300 generates the output signal that is applied directly to an actual trajectory of the autonomous system, to correct the actual trajectory such that the actual trajectory (and thus, the autonomous mechanical system) adheres to the predefined and stored planned trajectory.

Returning to FIG. 2, in exemplary embodiments, the closed-loop control system module 208 uses the closed-loop control system framework to generate an output signal that is transmitted (by the communication device 206) to the communicatively coupled autonomous mechanical system. In some embodiments, however, the computing device 200 is implemented as an integrated component or aspect of the planning and control modules of the autonomous mechanical system. In this case, the closed-loop control system module 208 uses the closed-loop control system framework to generate an output signal that is applied directly to an actual trajectory of the autonomous mechanical system, to correct the actual trajectory such that the actual trajectory (and thus, the autonomous mechanical system) follows the planned trajectory.

The autonomous mechanical system control module 210 is configured to generate control commands for the autonomous mechanical system based on the output signal of the explicit NMPC, after modification by the EHGO and the dynamic inversion to generate a modified output signal. The modified output signal includes modified operation parameters for the autonomous system (see reference 104 of FIG. 1), which compensate for system uncertainties and unknown values (e.g., unknown system model coefficients, unmeasured system states). The modified operation parameters are used by an autonomous operation module (see reference 110 of FIG. 1) of the autonomous mechanical system to perform autonomous operations to cause the autonomous system to adhere to a predefined and stored planned trajectory.

In practice, the closed-loop control system module 208 and/or the autonomous system control module 210 may be implemented with (or cooperate with) the at least one processor 202 to perform at least some of the functions and operations described in more detail herein. In this regard, the closed-loop control system module 208 and/or the autonomous system control module 210 may be realized as suitably written processing logic, application program code, or the like.

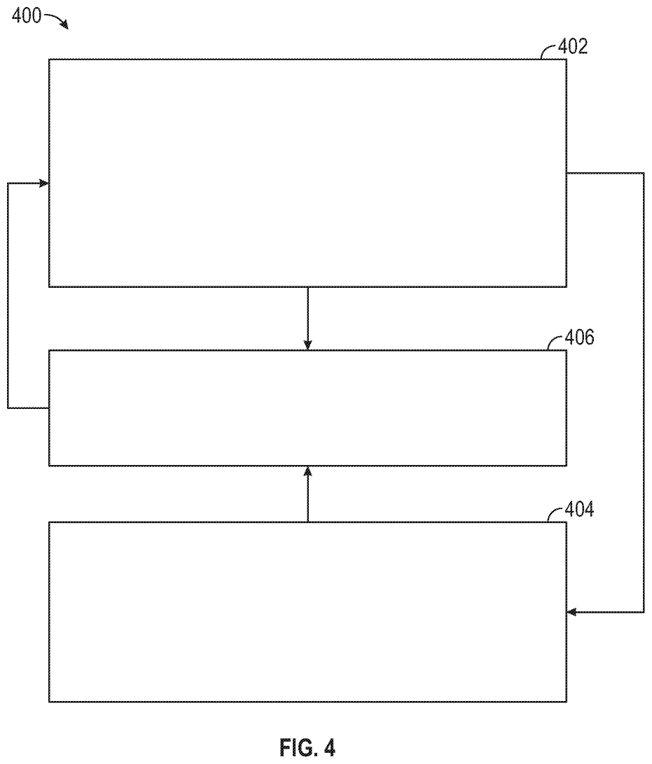

FIG. 4 is a diagram of control flow 400 for improving typical performance of an autonomous system, in accordance with the disclosed embodiments. As described herein, the control flow 400 is implemented using one or more computing devices (as shown in FIGS. 1-2, references 102, 200) which is one aspect of a system for improving typical performance of an autonomous system, as shown in FIG. 1.

As shown, the control flow 400 includes an explicit Nonlinear Model Predictive Control (NMPC) block 402, an Extended High-Gain Observer (EHGO) block 404, and a dynamic inversion block 406. To accommodate uncertain nonlinear systems in control applications for the autonomous system, one or more Extended High-Gain Observers (EHGOs), in the EHGO block 404, are used to estimate unmeasured system states, uncertainties, and external disturbances. The estimates generated by the EHGOs are provided to a dynamic inversion block 406, which computes estimated values for uncertain or unknown coefficients. Optimal gains for the system are determined by an explicit Nonlinear Model Predictive Control (NMPC), in the explicit NMPC block 402, which are also provided to the dynamic inversion block 406, to operate the autonomous system under optimal conditions.

The control flow 400 originates from an Ordinary Differential Equation (ODE) representation of a system model for the autonomous system, as follows: the problem is stated by considering a chain of integrators:

\dot{x}=Ax+Bf(x,z,u), where x(0)=x₀; ż=g(x,z), where z(0)=z₀; and

y=Cx; where A=block diagram [Aₗ, . . . , Aₘ],

B=block diagram [Bₗ, . . . , Bₘ], and

C=block diagram [Cₗ, . . . , Cₘ].

$${A}_{i} = {[ \begin{matrix}0 & 1 & 0 & … & 0 \\ 0 & 0 & 1 & … & 0 \\ ⋮ & ⋮ & ⋱ & ⋱ & ⋮ \\ 0 & 0 & … & 0 & 1 \\ 0 & 0 & … & … & 0\end{matrix} ]}_{{ρ}_{i} * {ρ}_{i}} , \\ {B}_{i} = {[ \begin{matrix}0 \\ 0 \\ … \\ 0 \\ 1\end{matrix} ]}_{{ρ}_{i} * 1} , {C}_{i} = {[ 1 , 0 , … , 0 ]}_{1 * {ρ}_{i}}$$

for 1≤i≤m and

$${\overline{f}}_{n} = {f}_{n} + {g}_{n} u = [ \begin{matrix}{f}_{n , 1} + {g}_{n , 1} {u}_{1} \\ ⋮ \\ {f}_{n , m} + {g}_{n , m} {u}_{ρ}\end{matrix} ] , \\ σ = [ \begin{matrix}{σ}_{1} ( x , z , u ) \\ ⋮ \\ {σ}_{m} ( x , z , u )\end{matrix} ]$$

To design the appropriate control system algorithms, four assumptions are made, including: (1) the functions f̅(x, u) and σ(x, z, u) are continuously differentiable; (2) the zero dynamics are stable; (3) the output of systems y=Cx has a well-defined, relative degree; and (4) the output y=Cx, and the reference signal w(t) are continuously differentiable with respect to time t.

The control flow 400 may be summarized as follows: first, under the assumption that states of the autonomous system (and any component subsystems) are known and that “perfect” models of the autonomous system are available for use (for which system dynamics may be modeled using parameter values that are defined, known, measured, or otherwise provided), the explicit Nonlinear Model Predictive Control (NMPC) is designed and incorporated into a closed-loop control system for the autonomous system. Second, under the assumptions that the system states are measurable and that the system dynamics are known (with the exception that an input coefficient matrix is unknown, but a positive definite value), the dynamic inverter is designed and incorporated into the closed-loop control system that includes the explicit NMPC. Third, under the assumptions that the system states are measurable, that the system dynamics are unknown (with the exception that the input coefficient matrix is a positive definite value), the Extended High-Gain Observers (EHGOs) and dynamic inverter are incorporated into the closed-loop control system to augment the explicit NMPC.

To design the explicit NMPC in the absence of uncertainties, a receding-horizon performance index is defined using the cost function:

J=½∫₀^{T}(y(t+τ)−w(t+τ))^{T}(y(t+τ)−w(t+τ))dτ,

where T is the predictive period. The control order r is defined if conditions of control signals are satisfied:

u^{(r)}(t+τ)≠α for some τ∈[0,T]; (A1)

u^{(k)}(t+τ)=α for some k>r and τ∈[0,T], (A2)

where u^{(k)}(t+τ) denotes the r^{th} of u(t+τ) with respect to τ.

Using the notation of Lie Derivative, repeated differentiation up to ρ+r times the output with respect to time is made as follows:

$$\dot{y} = {ℒ}_{f} Cx$$

$$⋮$$

$${y}^{( ρ - 1 )} ( t ) = {ℒ}_{f}^{ρ - 1} Cx$$

$${y}^{( ρ )} ( t ) = {ℒ}_{f}^{ρ} Cx = {ℒ}_{g} {ℒ}_{f}^{ρ - 1} Cxu ( t )$$

$$⋮$$

$${y}^{( ρ + r )} ( t ) = {ℒ}_{f}^{ρ + r} Cx + {p}_{r 1} ( u ( t ) , x ) + … + {p}_{rr} ( u ( t ) , … , {u}^{( r - 1 )} ( t ) ) + {ℒ}_{g} {ℒ}_{f}^{ρ - 1} {u}^{( r )} ( t )$$

where pᵣᵢ are functions of the state, input, and input's derivatives, i.e., x, u(t), \dot{u}(t), . . . ,u^{(r)}(t). It should be noted that y^{(ρ)} can be rewritten as:

y^{(ρ)}= [symbol] _{f}^{ρ}Cx+( [symbol] _{g} [symbol] _{f}^{ρ-1}Cx)u(t)=f̅ₙ+σ(x,z,u).

When σ(x, z, u)=0, then [symbol] f_{f}ρCx=fₙ and [symbol] _{g} [symbol] _{f}^{ρ-1}Cx=gₙ.

The output y(t+τ)=[y_{ρ1}, y_{ρ2}, . . . , y_{ρm}]^{T}∈R^{ρ} at future time τ is approximated using Taylor series expansion as follows:

$${y}_{i} ( t + τ ) \approx {y}_{i} ( t ) + τ {\dot{y}}_{i} ( t ) + … + \frac{{τ}^{r + {ρ}_{i}}}{( r + {ρ}_{i} ) !} {y}_{i}^{r + {ρ}_{i}} ( t ) ,$$

where i=ρᵢ, . . . , ρₘ, and ρ=ρ₁+ . . . +ρₘ.

The reference trajectory w(t+τ)=[w_{ρ1}, w_{ρ2}, . . . , w_{μm}]^{T}∈R^{ρ} is also approximated using Taylor series expansion:

$${w}_{i} ( t + τ ) \approx {w}_{i} ( t ) + τ {\dot{w}}_{i} ( t ) + … + \frac{{τ}^{r + {ρ}_{i}}}{( r + {ρ}_{i} ) !} {w}_{i}^{r + {ρ}_{i}} ( t ) ,$$

where i=ρᵢ, . . . , ρₘ.

The equations y(t+τ) and w(t+τ) can be rewritten as follows:

$$y ( t + τ ) = ( τ ) Y ( t ) , and w ( t + τ ) = ( τ ) W ( t ) , where$$

$$( τ ) = [ I τ … \frac{{τ}^{ρ + r}}{( ρ + r ) !} ] . \\ Y ( t ) = [ \begin{matrix}{y}^{( 0 )} \\ {y}^{( 1 )} \\ ⋮ \\ {y}^{( ρ )} \\ ⋮ \\ {y}^{( ρ + r )}\end{matrix} ] = [ \begin{matrix}Cx \\ {ℒ}_{f} Cx \\ ⋮ \\ {ℒ}_{f}^{ρ} Cx \\ ⋮ \\ {ℒ}_{f}^{ρ + r} Cx\end{matrix} ] + [ \begin{matrix}0 \\ ⋮ \\ 0 \\ H ( u ( t ) , \dot{u} , … , {u}^{( r )}\end{matrix} ]$$

$$W ( t ) = [ \begin{matrix}{w}^{( t )} \\ {w}^{( 1 )} \\ ⋮ \\ {w}^{( ρ )} \\ ⋮ \\ {w}^{( ρ + r )}\end{matrix} ]$$

$$H ( u , \dot{u} , … , {u}^{( r )} = [ \begin{matrix}{ℒ}_{g} {ℒ}_{f}^{ρ - 1} Cxu ( t ) \\ {p}_{11} ( u ( t ) , x ( t ) ) + {ℒ}_{g} {ℒ}_{f}^{ρ - 1} Cx \dot{u} ( t ) \\ ⋮ \\ {p}_{r 1} ( u ( t ) , x ( t ) ) + … + \\ {p}_{rr} ( u ( t ) , \dot{u} ( t ) , x ( t ) ) + {ℒ}_{g} {ℒ}_{f}^{ρ - 1} {u}^{( r )} ( t )\end{matrix} ]$$

To minimize the cost function J with respect to the input \dot{u}=[u^{T}, \dot{u}^{T}, . . . , u^{(r)}(t)^{T}]^{T}, i.e., (∂J/∂ū), there exists a necessary condition:

$$\frac{\partial J}{\partial \overline{u}} = 0 , i . e . , {( \frac{\partial J}{\partial \overline{u}} )}^{T} [ ] M + {( \frac{\partial H}{\partial \overline{u}} )}^{T} H ( \overline{u} ) = 0 ,$$

where [symbol] and [symbol] are derived from:

$$= {\int }_{0}^{T} {T}^{} ( τ ) ( τ ) d τ = [ \begin{matrix} & \\ & \end{matrix} ] .$$

Using the inevitability of [symbol] _{g} [symbol] _{f}^{ρ-1}Cx, i.e., a non-singular matrix (∂H/∂ū)≠0, the following is obtained:

H(ū)=−[ [symbol] I_{m(r+1)*m(r+1)}]M, (A.1):

where

$$M = [ \begin{matrix}{ℒ}_{f}^{0} Cx \\ ⋮ \\ {ℒ}_{f}^{ρ + r} Cx\end{matrix} ] - [ \begin{matrix}w ( t ) \\ ⋮ \\ {w}^{( ρ + r )} ( t )\end{matrix} ]$$

Using equation (A.1), the following is produced:

[symbol]

_{g} [symbol] _{f}^{ρ-1}Cxu(t)+KM_{ρ}+ [symbol] _{f}^{ρ}Cx−w^{ρ}(t)=0. (A.2):

The explicit input is determined as follows:

u(t)=( [symbol] _{g} [symbol] _{f}^{ρ-1}Cx)⁻¹ [−KM_{ρ}− [symbol] _{f}^{ρ}Cx+w^{ρ}], where K denotes the first m columns of the matrix [symbol] , and

M_{ρ}=[(Cx−w(t))^{T}( [symbol] _{f}Cx−\dot{w}(t))^{T} . . . ( [symbol] _{f}^{ρ-1}Cx−w^{(ρ-1)}(t)^{T}]^{T}

Based on the explicit NMPC, the dynamic inversion is used to find the solution of u(t) for the nonlinear map (equation A.2). In this case, the dynamic inversion is employed to resolve the uncertain input coefficient [symbol] _{g} [symbol] _{f}^{ρ-1}Cx. However, the uncertain input coefficient is a positive, definite value. Using dynamic inversion, the control is designed as follows: u\dot{u}(t)=−[ [symbol] _{g} [symbol] _{f}^{ρ-1}Cxu(t)+KM_{ρ}+ [symbol] _{f}^{ρ}Cx−w^{ρ}(t)].

To observe a principle of dynamic inversion, the singular perturbation method is used as follows: as μ→0, the following is achieved:

0=−[ [symbol] _{g} [symbol] _{f}^{ρ-1}Cxu(t)+KM_{ρ}+ [symbol] _{f}^{ρ}Cx−w^{ρ}(t), which is the same as equation (A.2). In the absence of uncertainties, i.e., σ(x, z, u)=0, the following is determined:

fₙ(x)= [symbol] _{f}^{ρ}Cx, and gₙ(x)= [symbol] _{g} [symbol] _{f}^{ρ-1}Cx.

To consider unmeasured system states and uncertainties in system as well as external disturbances, the Extended High-Gain Observer (EHGO) is designed as follows:

\hat{\dot{x}}=A\hat{x}+B[f̅ₙ+\hat{σ}(t)]+H(ε)(y−C\hat{x}), where

\hat{\dot{σ}}=H_{ρ+1}(y−C\hat{x}), \hat{x}(0)=\hat{x}₀, and \hat{σ}(0)=\hat{σ}₀, and where

\hat{σ}=[\hat{σ}₁, . . . , \hat{σ}ₘ]^{T} is the estimate of σ(x, z, u), and

H=block diagram [H₁, . . . , Hₘ], Hᵢ=[α_{i,1}/ε, . . . , α_{i,1},ρ_{i,ρ1}/ε^{ρi}]^{T}, and

Hₘ₊₁=[α₁,ρ₁/ε, . . . , αₘ,ρₘ/ε^{ρm+1}]^{T}.

Using the explicit Nonlinear Model Predictive Control (NMPC), the dynamic inversion, and the EHGO, the output feedback control is designed as follows:

u\dot{u}=−[fₙ(\hat{x}ₛ,u)+gₙ(\hat{x}ₛ)u+\hat{σ}ₛ+KM_{ρ}−w^{ρ}],

\hat{\dot{x}}=A\hat{x}+B[f̅ₙ+\hat{σ}(t)]+H(ε)(y−C\hat{x}),

\hat{\dot{σ}}=H_{ρ+1} (y−C\hat{x}), \hat{x}(0)=\hat{x}₀, and \hat{σ}(0)=\hat{σ}₀, where \hat{x}ₛ, \hat{σ}ₛ denote saturated estimates. The estimates from the EHGO are saturated to prevent peaking degrading the system performance and levels of the saturation are activated in the domain for state feedback. The overall structure of the control design is illustrated in the control flow 400 of FIG. 4.

As described herein, the control flow 400 includes the explicit NMPC block 402, the EHGO block 404, and the dynamic inversion block 406. The explicit NMPC block 402 operates in a slower time scale than that of the EHGO block 404 and the dynamic inversion block 406, and a nonlinear map in the presence of uncertainties is provided by the explicit NMPC block 402, according to the following equations (described previously):

fₙ(x)+gₙ(x)u+σ+KM_{ρ}−w^{ρ}(t)= [symbol] _{f}^{ρ}Cx+ [symbol] _{g} [symbol] _{f}^{ρ-1}Cx+KM_{ρ}−w^{(ρ)},

where σ(x, u, t) are uncertainties of the autonomous system, and

where KM_{ρ}−w^{(ρ)} represents reference data (see block 310 of FIG. 3).

The EHGO block 404 operates in a faster time scale than that of the explicit NMPC block 402 and the dynamic inversion block 406. To accommodate uncertain nonlinear systems in control applications for the autonomous system, one or more Extended High-Gain Observers (EHGOs), in the EHGO block 404, are used to estimate unmeasured system states, uncertainties, and external disturbances. The EHGO block 404 receives input parameters, including measurement parameters, according to the following equation: y(t)=Cx, from the explicit NMPC block 402, and performs estimations using the following equations (described previously):

\hat{\dot{x}}=A\hat{x}+B[f̅ₙ+\hat{σ}(t)]+H(ε)(y−C\hat{x}), \hat{\dot{σ}}=H_{ρ+1}(y−C\hat{x}), \hat{x}(0)=\hat{x}₀, and \hat{σ}(0)=\hat{σ}₀, where \hat{x}ₛ, \hat{σ}ₛ denote saturated estimates that are provided to the dynamic inversion block 406.

The dynamic inversion block 406 operates in an intermediate time scale that is faster than the slowest time scale used by the explicit NMPC block 402 and that is slower than the fastest time scale used by the EHGO block 404. The estimates generated by the EHGOs are provided to a dynamic inversion block 406, which computes estimated values for uncertain or unknown coefficients. Thus, the dynamic inversion block 406 computes and provides dynamic inversion of input parameters provided by the EHGO block 404 and the explicit NMPC block 402, according to the following equation (described previously): u\dot{u}=−[fₙ(\hat{x}ₛ,u)+gₙ(\hat{x}ₛ)u+\hat{σ}ₛ+KM_{ρ}−w^{ρ}]. The dynamic inversion block 406 computes and provides parameter u(t) to the explicit NMPC block 402, such that the explicit NMPC block 402 is capable of computing a control signal used to operate the autonomous system under optimal conditions.

### Exemplary Embodiment: Autonomous Vehicle Application

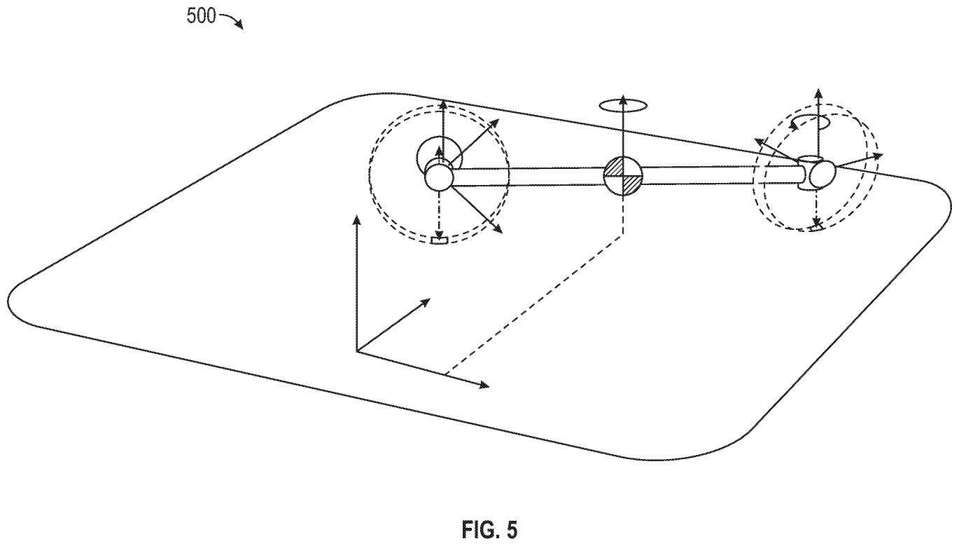

FIG. 5 is a diagram of an exemplary embodiment of a vehicle model 500 applicable to an autonomous system, in accordance with the disclosed embodiments. In this embodiment, the autonomous system is implemented as an autonomous vehicle (i.e., autonomous car/automobile). Although the embodiment shown in FIG. 5 is an autonomous vehicle, it should be appreciated that other embodiments of the autonomous system may be implemented as ground, aerial, or underwater vehicles requiring autonomous vehicle control; walking bipedal robots requiring autonomous motor control; prosthetic technologies requiring autonomous human body motor control; or the like, as described previously with regard to FIG. 1.

FIG. 5 illustrates system dynamics for an autonomous vehicle, as a simplified bicycle model of the autonomous vehicle, which has been normalized using Kane's method for dynamic modeling. Explicit Nonlinear Model Predictive Control (NMPC) uses the normal form to perform control design, wherein the normal form is a system form that describes the system behaviors using Ordinary Differential Equations (ODEs). Kane's method is typically used to describe dynamics of the system, and Kane's method does not include the normal form. As described herein, the form described by Kane's method is converted into the normal form for use in closed-loop system control of the autonomous vehicle. It should be appreciated that the simplified model (and associated algorithms describing behavior/dynamics of the model) shown does not include computations to accommodate the use of a vehicle transmission or other types of gear reduction onboard the vehicle. However, in practice, the techniques described herein may be applied to systems that include a transmission or other types of gear reduction, as required for the particular application, via expansion of the system dynamics model to include the vehicle engine and transmission. As shown, generalized coordinates q₁, . . . , q₆ are used. Coordinates q₁ and q₂ denote the position of the center of mass of the chassis; coordinate q₃ is the yaw angle; coordinate q₄ is the steering angle; coordinates q₅ and q₆ are the rear and front wheels tire angles, respectively.

Using Kane's method and its included nonholonomic constraints, the applicable state space equations are obtained using the following:

$$[ \begin{matrix}{\dot{x}}_{1} \\ {\dot{y}}_{1} \\ {\dot{z}}_{1} \\ {\dot{z}}_{2} \\ {\dot{z}}_{3} \\ {\dot{z}}_{4}\end{matrix} ] = [ \begin{matrix}{x}_{2} \\ {y}_{2} \\ {d}_{1} ( x , z ) \\ {d}_{2} ( x , z ) \\ {d}_{3} ( x , z ) \\ {d}_{4} ( x , z )\end{matrix} ] , \\ [ \begin{matrix}{\dot{x}}_{2} \\ {\dot{y}}_{2}\end{matrix} ] = {\overline{b}}_{1} [ \begin{matrix}{x}_{2} \\ {y}_{2}\end{matrix} ] + {\overline{b}}_{2} ( x , z ) + {\overline{M}}^{- 1} [ \begin{matrix}{τ}_{1} \\ {τ}_{2}\end{matrix} ] , \\ [ \begin{matrix}{x}_{2} \\ {y}_{2}\end{matrix} ] = [ \begin{matrix}1 & 0 & {0}_{1 * 3} \\ 0 & 1 & {0}_{1 * 3}\end{matrix} ] [ \begin{matrix}x \\ z\end{matrix} ] = [ \begin{matrix}{x}_{1} \\ {y}_{1}\end{matrix} ] ,$$

where

x=[x₁, x₂]^{T}, z=[z₁, . . . , z₄]^{T}, q=[q₁, q₂, q₃, . . . , q₆]^{T}=[x₁, y₁, z₁, . . . , z₄]^{T}; b₁ and b₂ are 2×2 matrices; M̅⁻¹ is a 2×2 inertia matrix and a positive definite value; and [y₁, y₂]^{T} is a measurement vector. The vector [z₁, . . . , z₄]^{T} is a stable, zero-dynamics vector.

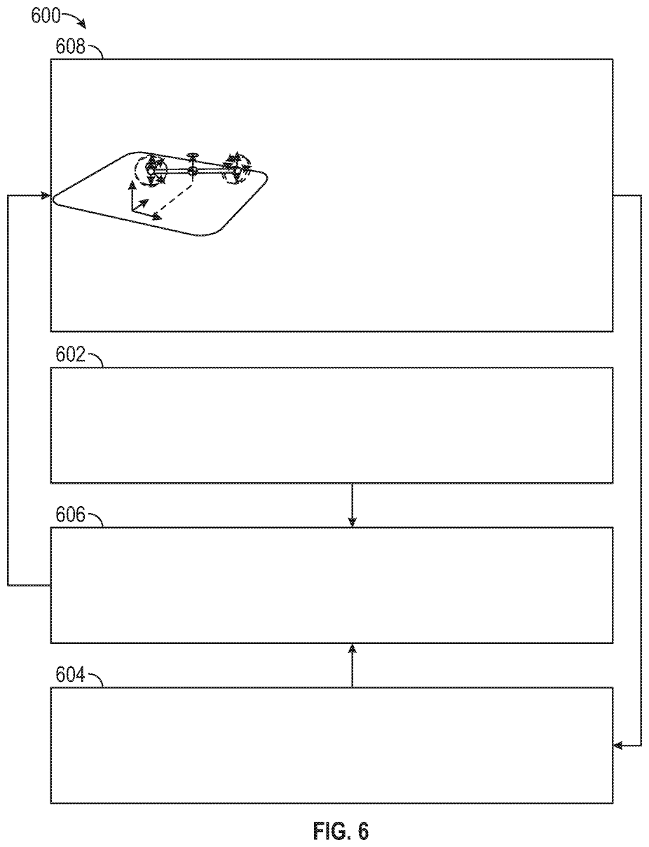

FIG. 6 is a diagram of a control algorithm 600 for an exemplary embodiment of a vehicle model applicable to an autonomous system, in accordance with the disclosed embodiments. The control algorithm shown in FIG. 6 is the control application specific to an autonomous vehicle embodiment, wherein a generalized control application applicable to autonomous systems was described previously with regard to FIG. 4, and wherein the autonomous vehicle embodiment was described previously with regard to FIG. 5. Thus, the generalized equations (reference 400, FIG. 4) applicable to system models of autonomous mechanical systems, are applied to the specific system model of the autonomous vehicle (reference 500, FIG. 5) and manipulated to produce the control algorithm 600 shown.

As shown, the control algorithm 600 includes an explicit Nonlinear Model Predictive Control (NMPC) block 602; an Extended High-Gain Observer (EHGO) block 604; a dynamic inversion block 606; and a system dynamics block 608. The explicit NMPC block 602 provides an explicit NMPC framework for the autonomous vehicle, in the presence of uncertainties, as follows:

$${\overline{b}}_{1} [ \begin{matrix}{x}_{2} \\ {y}_{2}\end{matrix} ] + {\overline{b}}_{2} ( x , z ) + {\overline{M}}^{- 1} [ \begin{matrix}{τ}_{1} \\ {τ}_{2}\end{matrix} ] + {KM}_{ρ} - {w}^{( 2 )} = [ \begin{matrix}0 \\ 0\end{matrix} ] .$$

The EHGO block 604 estimates uncertain, unmeasured, and/or otherwise unknown values for the system model, as follows:

\hat{\dot{x}}=A\hat{x}+B[\hat{σ}(t)+Mₙ⁻¹u(t)]+H(ε)(y−C\hat{x}), and

\hat{\dot{σ}}=H_{ρ+1}(y−C\hat{x}).

The dynamic inversion block 606 computes estimated values for unknown input

$$μ [ \begin{matrix}{\dot{τ}}_{1} \\ {\dot{τ}}_{2}\end{matrix} ] = - [ \hat{σ} ( t ) + {\overline{M}}_{n}^{- 1} [ \begin{matrix}{τ}_{1} \\ {τ}_{2}\end{matrix} ] + {KM}_{ρ} - {w}^{( 2 )} ] .$$

coefficients of the system model, as follows:

The system dynamics block 608 provides mathematical descriptions for the autonomous vehicle systems, as described previously with regard to FIG. 5.

The control algorithm 600 is representative of a closed-loop control system implemented by a computing device (see reference 102, FIG. 1; reference 200, FIG. 2). The closed-loop control system includes the explicit NMPC block 602, which receives control inputs (including historical control moves for the autonomous vehicle), and provides a framework for providing optimal gains to the closed-loop control system for the autonomous vehicle. The explicit NMPC block 602 optimizes a cost function (see reference 402, FIG. 4) using a system model (represented by the system dynamics block 608) to generate operation parameters and control commands for the autonomous vehicle. Inputs to the explicit NMPC framework include one or more control inputs, a planned trajectory for the autonomous vehicle, and a system model of the autonomous vehicle. The explicit NMPC framework uses the input control data to generate operation parameters for the autonomous vehicle, including control commands for autonomous operation of the vehicle based on the planned trajectory. Output of the explicit NMPC framework is then modified (via EHGO and/or dynamic inversion) to generate modified operation parameters, including modified control commands for accuracy in vehicle performance that exceeds performance using un-modified operation parameters and un-modified control commands.

Model Predictive Control (MPC) provides functionality for a computing device to control an autonomous system under optimal conditions, using constraints that include system states and system inputs based on system models. Linear MPCs use long-range generalized predictive control, which include polynomials to linearize outputs. Nonlinear MPCs (NMPCs) vary from linear MPCs, and optimizations performed by NMPCs are resource-intensive and typically unstable. However, stability of NMPCs is controlled using a dual-mode control approach, wherein a receding horizon control is used outside of the terminal region, and when the states reach the boundary of the terminal region, a quasi-infinite horizon NMPC scheme is used, including an on-line objective function composed of a finite horizon cost and a terminal cost. By employing the cost function, the terminal function bounds the infinite horizon cost of the nonlinear system and stability is achieved. The explicit NMPC framework approximates the outputs of continuous-time systems using Taylor series with the number of relative degrees and input derivatives. The explicit NMPC determines a solution explicitly, thereby (1) reducing the intensive computation burden that is typical for NMPCs, and (2) ensuring stability of the closed-loop control system. However, the explicit NMPC does not consider imperfections and unknown values associated with the system model, including unmeasured system states, system model uncertainties, unknown input coefficients, system disturbances, and the like. By not considering imperfections and unknown values of the system model, control of the autonomous vehicle accumulates error and performance of the autonomous vehicle degenerates.

The dynamic inversion block 606 receives input values from the explicit NMPC block 602 (e.g., the optimal gains) and the EHGO block 604 (e.g., estimation data, as described below), and modifies the input values to accommodate unknown input coefficients of the system model (represented by the system dynamics block 608).

Control of the autonomous vehicle begins with the EHGO block 604 receiving a current position of the autonomous vehicle: y=[x₁, y₁]^{T} from one or more vehicle onboard sensors. Data received from sensors onboard the autonomous system (e.g., the autonomous vehicle) may also be referred to as measured data or measured system states. In the exemplary embodiment shown, the applicable vehicle onboard sensor may be a Global Positioning System (GPS), an odometry system, a local range-finding system (e.g., laser range-finding), or the like, and the current position includes data from the applicable sensor that indicates the position of the vehicle. The EHGO block 604 also receives system model data from the system dynamics block 608 in the form of Ordinary Differential Equations (ODE) representative of the dynamics of the autonomous vehicle and any component subsystems. Using the system model data (from system dynamics block 608) and the current vehicle position data (measured by vehicle sensors), the EHGO block 604 estimates acceleration values and velocity values for a planned trajectory that has been predefined and stored for use by the autonomous vehicle. The estimated values are represented by: \hat{x}ₛ, \hat{σ}ₛ.

The estimated values from the EHGO block 604 are provided to the dynamic inversion block 606. The dynamic inversion block 606 uses the received estimation values (from the EHGO block 604) and the received optimal gains (from the explicit NMPC block 602) to accommodate unknown input coefficients associated with the system model and the cost function (described previously with regard to the explicit NMPC block 602). The result of the dynamic inversion is the state vector u(t), which is provided by the dynamic inversion block 606 to the system dynamics block 608, for application to the system model computations and transmission to the autonomous driving module of the autonomous vehicle. In the exemplary embodiment shown, u(t) includes a rear-wheel or front-wheel torque value and a yaw moment, computed to control the autonomous vehicle and correct the current trajectory of the vehicle, such that the autonomous vehicle adheres more closely to a predefined, planned trajectory after the correction.

As shown, the control output from the explicit NMPC is modified using: (i) the EHGO estimates of unmeasured system states and external disturbances, and (ii) the dynamic inversion computed values for the unknown input coefficients. Unknown and/or uncertain values in system modeling produces less than optimal results and potentially degenerative performance for autonomous systems. Degenerative performance for an autonomous system indicates increased error from a set of expected results, such as an increasing offset from a planned trajectory for the autonomous vehicle. Here, by modifying the control output from the explicit NMPC to accommodate potential error or degenerating performance, the control algorithm 600 improves performance of the autonomous vehicle by reducing or eliminating error caused by unknown and uncertain values for the control algorithm, resulting in closer adherence of the autonomous vehicle to the planned trajectory than without the modifications provided by the EHGO block 604 and the dynamic inversion block 606.

In numerical simulations, the position of the car (y=[x₁, y₁]^{T}) is measured. The position information is used to estimate [x₂, y₂]^{T}, and uncertain terms

b̅₁[x₂ y₂]^{T}+b̅₂ (x, z)[\hat{x}₂, ŷ₂]^{T} and \hat{σ}(t) are estimates of

b̅₁ [x₂ y₂]^{T}+\hat{b}₂ (x, z) and \hat{σ}(t), respectively.

In the fastest time scale portion of the control algorithm 600 (e.g., the EHGO block 604), the EHGO provides estimates for [\hat{x}₂, ŷ₂]^{T} and \hat{σ}(t). In an intermediate time scale portion of the control algorithm 600 (e.g., the dynamic inversion block 606), the dynamic inverter uses the EHGO-provided estimates to find the solution of the uncertain map and to deal with the uncertain input coefficient M̅⁻¹=M̅ₙ⁻¹+M̅_{δ}⁻¹ where M̅ₙ⁻¹ is the nominal value and M̅_{δ}⁻¹ is an uncertainty. The uncertain nonlinear control conditions are created by the explicit Nonlinear Model Predictive Control (NMPC), in order to find optimal conditions for the system in the slowest time scale.

Under normal conditions and without the use of modifications to the explicit NMPC output, the explicit NMPC generates control commands for the autonomous vehicle that eventually result in an actual vehicle trajectory that deviates from a planned trajectory for the vehicle, due to the presence of unknown system values, unknown system states, unknown system model input coefficients, system uncertainties, and external system disturbances. However, by using the multi-time-scale structure described herein, which modifies the explicit NMPC output before use, the control algorithm 600 is capable of autonomous vehicle control such that the actual trajectory of the vehicle follows the given reference trajectory (i.e., the planned trajectory) precisely in the presence of unmeasured states and uncertainties while the optimal conditions are satisfied.

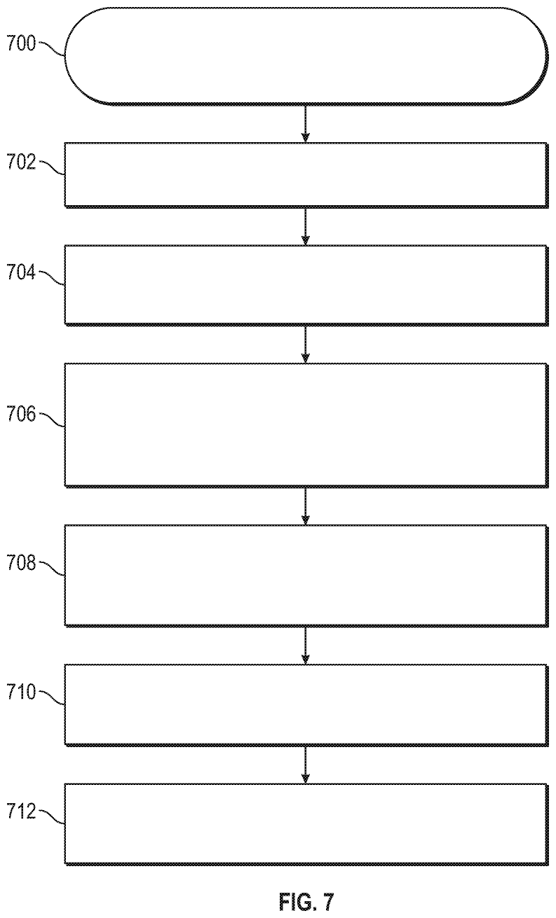

FIG. 7 is a flow chart that illustrates an embodiment of a process 700 for using a closed-loop control system comprising an explicit Nonlinear Model Predictive Control (NMPC) to control an autonomous system, in accordance with the disclosed embodiments. First, the process 700 receives one or more control inputs, via the closed-loop control system for the autonomous system (step 702). Control inputs may include historical control move data, reference load data (e.g., a reference trajectory and other control move data for a particular autonomous mechanical system), and output from a dynamic inverter using Extended High-Gain Observer (EHGO) output data and explicit NMPC output data. Control inputs are obtained via a closed-loop control system, and are used by the explicit NMPC for further analysis.

Next, the process 700 obtains a system model for the autonomous system, the system model comprising mathematical descriptions of system dynamics of the autonomous system (step 704). The system model includes a plurality of control algorithms representative of system dynamics for the autonomous system, wherein the plurality of control algorithms are in the form of Ordinary Differential Equations (ODE). System model ODE descriptions are compatible with ODE representations of dynamic inversion algorithms and Extended High-Gain Observer (EHGO) algorithms, such that dynamic inversion and/or EHGO operations may be performed using applicable system dynamics algorithms and appropriate input data.

The process 700 then computes operation parameters for the autonomous system using the explicit NMPC framework, the one or more control inputs, and the mathematical descriptions, wherein output of the explicit NMPC comprises the operation parameters (step 706). A typical Model Predictive Control (MPC) system is a multivariable control algorithm that uses an internal dynamic model of the process (e.g., the system model), a history of past control moves (e.g., the control inputs), and an optimization cost function (J) over the receding prediction horizon, to calculate optimum control moves and associated operation parameters to produce the optimum control moves for the autonomous system. The optimization cost function (J) is performed using a dual-mode control approach, wherein a receding horizon control is used outside a terminal region, and when states of the system model reach a boundary of the terminal region, using a virtual linear stabilizing control including a quasi-infinite horizon NMPC scheme using an on-line objective function comprising a finite horizon cost and a terminal cost. The explicit NMPC framework computes output values explicitly, in order to reduce the intensive computation burden, by estimating output values of continuous-time systems of the system model using Taylor series (to produce approximated outputs) and explicitly calculating the optimum control moves based on the approximated outputs.

The explicit NMPC framework assumes that all autonomous system states are known to the process 700 and that the obtained system model for the autonomous system is perfect and does not include error, uncertainty, or incomplete or unknown values. However, for a typical explicit NMPC, this is not the case, and modification to the output of the explicit NMPC are necessary to accommodate the imperfections in the system model to generate control commands with increased accuracy.

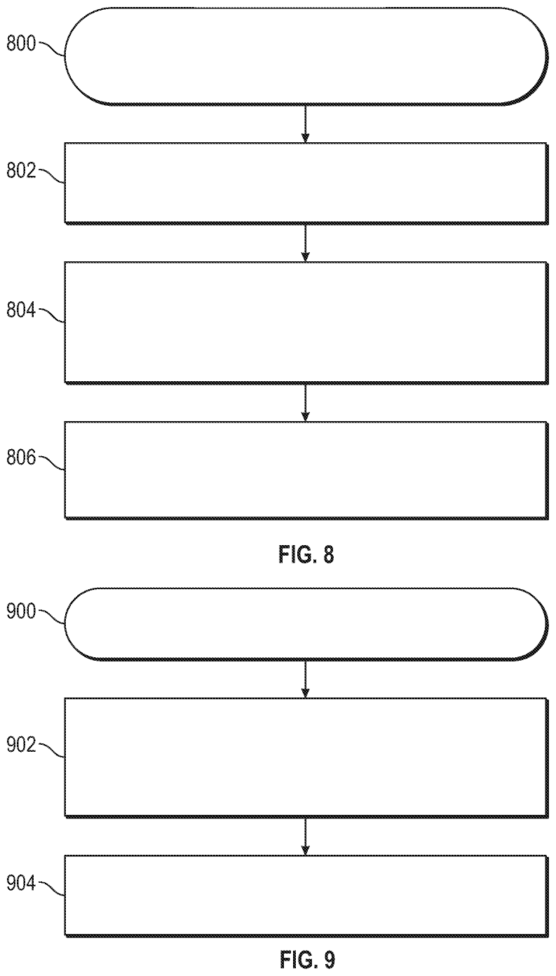

The process 700 modifies the output of the explicit NMPC to consider unmeasured system states, unknown system model values, and external disturbances to the autonomous system, to create modified operation parameters (step 708). Suitable methodologies for modifying the output of the explicit NMPC are described below with reference to FIGS. 8 and 9. In the context of the present disclosure, output of the explicit NMPC may be modified using an Extended High-Gain Observer (EHGO) (FIG. 8), dynamic inversion (FIG. 9), or a combination of both of the EHGO and dynamic inversion, as described previously with regard to FIG. 3.

The process 700 generates a modified output signal for the closed-loop control system (step 710). Here, the modified output signal comprises the modified operation parameters and is used as a control signal for the autonomous system.

In some embodiments, the process 700 is implemented using a standalone controller or computing device that is communicatively coupled to the autonomous system. In this case, the process 700 transmits the modified output signal of the closed-loop control system to the autonomous system circuitry and/or control modules, to control operation of the autonomous system using the modified operation parameters (step 712).

In other embodiments, the process 700 is implemented using a controller or computing device that is integrated into, and is co-located with, the autonomous system control circuitry and/or control modules. In this case, the process 700 uses the modified output signal to directly control operation of the autonomous system. In this embodiment, the process 700 applies a state vector to a trajectory of the autonomous system, the state vector comprising the modified operation parameters; the process 700 adjusts the trajectory based on the state vector, to generate a corrected trajectory; and the process 700 operates the autonomous system according to the corrected trajectory.

FIG. 8 is a flow chart that illustrates an embodiment of a process 800 for modifying explicit Nonlinear Model Predictive Control (NMPC) generated operation parameters using an Extended High-Gain Observer (EHGO), in accordance with the disclosed embodiments. It should be appreciated that the process 800 described in FIG. 8 represents one embodiment of step 708 described above in the discussion of FIG. 7, including additional detail.

The process 800 obtains measured system states for the autonomous system, via one or more sensors onboard the autonomous system (step 802). As described previously with regard to FIGS. 1-6, the process 800 uses an EHGO to estimate values for system uncertainties (e.g., unmeasured system states, external disturbances) to improve computation of operation parameters of the autonomous system. In embodiments where the autonomous system is implemented as a vehicle, the measured system states may include position data for the autonomous system, such as Global Positioning System (GPS) data or other location data.

The process 800 uses an EHGO to estimate the unmeasured system states and the external disturbances based on the measured system states, to generate estimated unmeasured system states and estimated external disturbances (step 804). The process 800 obtains input values for the EHGO of the closed-loop control system, including (i) measurements received from sensors onboard the autonomous system, and (ii) the system model associated with the autonomous system. The EHGO is a system that provides an estimate of the internal state of the autonomous system, using measurements of the input and output of the autonomous system. As described herein, the system is modeled using Ordinary Differential Equations (ODE), and the process 800 uses the EHGO to estimate values for the system uncertainties using ODE and the input measured values according to the system model. In embodiments where the autonomous system is implemented as a vehicle, the process 800 estimates velocity data and acceleration data for the vehicle, based on the vehicle position data and the applicable ODE system model.

The process 800 generates the modified output signal comprising the modified operation parameters based on the estimated unmeasured system states and the estimated external disturbances (step 806). In some embodiments (as described with regard to FIGS. 3, 4, and 6), the process 800 provides the EHGO-estimated values to a dynamic inverter of the closed-loop control system 300. In embodiments where the autonomous system is implemented as a vehicle, the process 800 generates a modified output signal for the closed-loop control system, wherein the modified output signal includes a rear-wheel torque value or a front-wheel torque value and a yaw moment that are used to control operation of the autonomous vehicle.

FIG. 9 is a flow chart that illustrates an embodiment of a process 900 for modifying explicit Nonlinear Model Predictive Control (NMPC) generated operation parameters using dynamic inversion, in accordance with the disclosed embodiments. It should be appreciated that the process 900 described in FIG. 9 represents one embodiment of step 708 described above in the discussion of FIG. 7, including additional detail.

The process 900 uses a dynamic inverter to compute values of unknown input coefficients for a system model of the autonomous system, wherein the unknown system model values comprise at least the unknown input coefficients (step 902). As described with regard to FIGS. 3, 4, and 6, the dynamic inverter receives input values from the explicit NMPC (including explicit NMPC-generated optimal gains) and the Extended High-Gain Observer (EHGO) (including estimation data), and modifies the input values to accommodate unknown input coefficients of the system model.

The process 900 generates the modified output signal comprising the modified operation parameters based on the values of the unknown input coefficients (step 904). The dynamic inverter uses the received estimation values and the received optimal gains to accommodate unknown input coefficients associated with the system model and the cost function optimized by the explicit NMPC. The dynamic inverter generates a state vector that includes optimized or corrected operation parameters for the autonomous system, as described with regard to FIG. 6.

The closed-loop control system includes the explicit NMPC, which receives control inputs and a system model to generate operation parameters for continued control of the autonomous system. In the exemplary embodiment described with regard to FIG. 6, the control inputs may include an input torque value from rear wheels of an autonomous vehicle, including a torque coefficient comprising an inverse term of an inertia matrix, wherein the unknown input coefficients comprise at least the torque coefficient. In this particular embodiment, the process 900 uses the dynamic inverter to compute the values of the unknown input coefficients, and generates a state vector for control of the autonomous vehicle. The state vector includes a rear-wheel or front-wheel torque value and a yaw moment, computed to control the autonomous vehicle and correct the current trajectory of the vehicle, such that the autonomous vehicle adheres more closely to a predefined, planned trajectory after the correction.

The various tasks performed in connection with processes 700-900 may be performed by software, hardware, firmware, or any combination thereof. For illustrative purposes, the preceding descriptions of processes 700-900 may refer to elements mentioned above in connection with FIGS. 1-6. In practice, portions of processes 700-900 may be performed by different elements of the described system. It should be appreciated that processes 700-900 may include any number of additional or alternative tasks, the tasks shown in FIGS. 7-9 need not be performed in the illustrated order, and each of processes 700-900 may be incorporated into a more comprehensive procedure or process having additional functionality not described in detail herein. Moreover, one or more of the tasks shown in FIGS. 7-9 could be omitted from embodiments of the processes 700-900 as long as the intended overall functionality remains intact.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The preceding description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for using a closed-loop control system to control an autonomous mechanical system, the closed-loop control system comprising an explicit Nonlinear Model Predictive Control (NMPC) framework, and the method comprising:
computing operation parameters for the autonomous mechanical system using the closed-loop control system comprising the explicit NMPC framework, wherein output of the explicit NMPC framework comprises the operation parameters;
modifying the output of the explicit NMPC framework to consider unmeasured system states, unknown system model values, and external disturbances to the autonomous mechanical system, to create modified operation parameters, by:
obtaining measured system states for the autonomous mechanical system, via one or more sensors onboard the autonomous mechanical system;
using an extended high-gain observer (EHGO) to estimate the unmeasured system states and the external disturbances based on the measured system states, to generate estimated unmeasured system states and estimated external disturbances; and
using a dynamic inverter to compute values of unknown input coefficients for a system model of the autonomous mechanical system, wherein the unknown system model values comprise at least the unknown input coefficients;
generating a modified output signal for the closed-loop control system, the modified output signal comprising the modified operation parameters, based on the estimated unmeasured system states and the estimated external disturbances and the values of the unknown input coefficients; and
transmitting the modified output signal of the closed-loop control system, to control operation of the autonomous mechanical system using the modified operation parameters.

2. The method of claim 1, further comprising:
controlling the operation of the autonomous mechanical system, by:
applying a state vector to a trajectory of the autonomous mechanical system, the state vector comprising the modified operation parameters;
adjusting the trajectory, based on the state vector, to generate a corrected trajectory; and
operating the autonomous mechanical system using the corrected trajectory.

3. The method of claim 1, further comprising:
receiving one or more control inputs, via the closed-loop control system for the autonomous mechanical system;
obtaining a system model for the autonomous mechanical system, wherein the system model comprises one or more mathematical descriptions of system dynamics of the autonomous mechanical system; and
computing the operation parameters for the autonomous mechanical system, using the one or more control inputs and the one or more mathematical descriptions, as input parameters for the explicit NMPC framework.

4. The method of claim 1, further comprising:
obtaining position data for the autonomous mechanical system, wherein the measured system states comprise at least the position data;
estimating velocity data and acceleration data for the autonomous mechanical system, based on the position data, via the EHGO, to generate estimated velocity data and estimated acceleration data, wherein the estimated unmeasured system states comprise the estimated velocity data and the estimated acceleration data; and
generating the modified output signal comprising the modified operation parameters based on the estimated velocity data, the estimated acceleration data, and the estimated external disturbances.

5. The method of claim 1, further comprising:
receiving an input torque value from rear wheels of an autonomous vehicle, the input torque value including a torque coefficient comprising an inverse term of an inertia matrix, wherein the autonomous mechanical system comprises the autonomous vehicle, and wherein the unknown input coefficients comprise at least the torque coefficient;
computing the values based on the torque coefficient, via the dynamic inverter; and
generating the modified output signal comprising the modified operation parameters based on the values of the unknown input coefficients.

6. The method of claim 1, wherein computing the operation parameters for the autonomous mechanical system further comprises:
receiving input values comprising at least a system model of the autonomous mechanical system and historical control move data, by the explicit NMPC framework of the closed-loop control system;
calculating optimum control moves for the autonomous mechanical system, using an optimization cost function over a receding prediction horizon, by the explicit NMPC framework; and
computing the operation parameters for the autonomous mechanical system based on the optimum control moves.

7. The method of claim 6, further comprising stabilizing the closed-loop control system, by:
performing the optimization cost function using a dual mode control approach, wherein a receding horizon control is used outside a terminal region; and
when states of the system model reach a boundary of the terminal region,
performing the optimization cost function using a virtual linear stabilizing control including a quasi-infinite horizon NMPC scheme using an on-line objective function comprising a finite horizon cost and a terminal cost.

8. The method of claim 6, further comprising reducing an intensive computation burden for calculating a nonlinear optimization, by:
estimating output values of continuous-time systems of the system model using Taylor series, to produce approximated output values; and
explicitly calculating the optimum control moves, based on the approximated output values.

9. A controller device for an autonomous mechanical system, the controller device comprising:
a system memory element, configured to store and maintain at least a closed-loop control system, an explicit Nonlinear Model Predictive Control (NMPC) framework, and one or more system models for the autonomous mechanical system;
a communication device, configured to transmit and receive communications including control instructions and control system feedback for the autonomous mechanical system; and
at least one processor, communicatively coupled to the system memory element and the communication device, the at least one processor configured to:
compute operation parameters for the autonomous mechanical system using the closed-loop control system comprising the explicit NMPC framework, wherein output of the explicit NMPC framework comprises the operation parameters;
modify the output of the explicit NMPC framework to consider unmeasured system states, unknown system model values, and external disturbances to the autonomous mechanical system, to create modified operation parameters, by:
obtaining measured system states for the autonomous mechanical system, via one or more sensors onboard the autonomous mechanical system;
using an extended high-gain observer (EHGO) to estimate the unmeasured system states and the external disturbances based on the measured system states, to generate estimated unmeasured system states and estimated external disturbances; and
using a dynamic inverter to compute values of unknown input coefficients for a system model of the autonomous mechanical system, wherein the unknown system model values comprise at least the unknown input coefficients;
generate a modified output signal for the closed-loop control system, the modified output signal comprising the modified operation parameters, based on the estimated unmeasured system states and the estimated external disturbances and the values of the unknown input coefficients; and
transmit the modified output signal of the closed-loop control system, to control operation of the autonomous mechanical system using the modified operation parameters.

10. The controller device of claim 9, wherein the at least one processor is further configured to:
control the operation of the autonomous mechanical system, by:
applying a state vector to a trajectory of the autonomous mechanical system, the state vector comprising the modified operation parameters;
adjusting the trajectory, based on the state vector, to generate a corrected trajectory; and
operating the autonomous mechanical system using the corrected trajectory.

11. The controller device of claim 9, wherein the at least one processor is further configured to:
receive one or more control inputs, via the communication device for the closed-loop control system for the autonomous mechanical system;
obtain a system model for the autonomous mechanical system, wherein the system model comprises one or more mathematical descriptions of system dynamics of the autonomous mechanical system; and
compute the operation parameters for the autonomous mechanical system, using the one or more control inputs and the one or more mathematical descriptions, as input parameters for the explicit NMPC framework.

12. The controller device of claim 9, wherein the at least one processor is further configured to:
receive an input torque value from rear wheels of an autonomous vehicle, the input torque value including a torque coefficient comprising an inverse term of an inertia matrix, wherein the autonomous mechanical system comprises the autonomous vehicle, and wherein the unknown input coefficients comprise at least the torque coefficient;
compute the values based on the torque coefficient, via the dynamic inverter; and
generate the modified output signal comprising the modified operation parameters based on the values of the unknown input coefficients.

13. The controller device of claim 9, wherein the at least one processor is further configured to:
receive input values comprising at least a system model of the autonomous mechanical system and historical control move data, via the explicit NMPC framework of the closed-loop control system;
calculate optimum control moves for the autonomous mechanical system, using an optimization cost function over a receding prediction horizon, via the explicit NMPC framework; and
compute the operation parameters for the autonomous mechanical system based on the optimum control moves.

14. The controller device of claim 13, wherein the at least one processor is further configured to:
stabilize the closed-loop control system, by:
performing the optimization cost function using a dual mode control approach, wherein a receding horizon control is used outside a terminal region; and
when states of the system model reach a boundary of the terminal region,
performing the optimization cost function using a virtual linear stabilizing control including a quasi-infinite horizon NMPC scheme using an on-line objective function comprising a finite horizon cost and a terminal cost.

15. The controller device of claim 13, wherein the at least one processor is further configured to:
reduce an intensive computation burden for calculating a nonlinear optimization, by:
estimating output values of continuous-time systems of the system model using Taylor series, to produce approximated output values; and
explicitly calculating the optimum control moves, based on the approximated output values.

16. A non-transitory, computer-readable medium containing instructions thereon, which, when executed by a processor, perform a method for using a closed-loop control system to control an autonomous mechanical system, the closed-loop control system comprising an explicit Nonlinear Model Predictive Control (NMPC) framework, and the method comprising:
receiving one or more control inputs as input parameters for the explicit NMPC framework, via the closed-loop control system for the autonomous mechanical system;
obtaining a system model for the autonomous mechanical system, wherein the system model comprises one or more mathematical descriptions of system dynamics of the autonomous mechanical system;
computing operation parameters for the autonomous mechanical system, using the one or more control inputs and the one or more mathematical descriptions, using the closed-loop control system comprising the explicit NMPC framework, wherein output of the explicit NMPC framework comprises the operation parameters;
modifying the output of the explicit NMPC framework to consider unmeasured system states, unknown system model values, and external disturbances to the autonomous mechanical system, to create modified operation parameters, by:
obtaining measured system states for the autonomous mechanical system, via one or more sensors onboard the autonomous mechanical system;
using an extended high-gain observer (EHGO) to estimate the unmeasured system states and the external disturbances based on the measured system states, to generate estimated unmeasured system states and estimated external disturbances; and
using a dynamic inverter to compute values of unknown input coefficients for a system model of the autonomous mechanical system, wherein the unknown system model values comprise at least the unknown input coefficients;
generating a modified output signal for the closed-loop control system, the modified output signal comprising the modified operation parameters, based on the estimated unmeasured system states and the estimated external disturbances and the values of the unknown input coefficients; and
controlling operation of the autonomous mechanical system using the modified output signal, by:
applying a state vector to a trajectory of the autonomous mechanical system, the state vector comprising the modified operation parameters;
adjusting the trajectory, based on the state vector, to generate a corrected trajectory; and
operating the autonomous mechanical system using the corrected trajectory.

17. The non-transitory, computer-readable medium of claim 16, wherein the method further comprises:
obtaining position data for the autonomous mechanical system, wherein the measured system states comprise at least the position data;
estimating velocity data and acceleration data for the autonomous mechanical system, based on the position data, via the EHGO, to generate estimated velocity data and estimated acceleration data, wherein the estimated unmeasured system states comprise the estimated velocity data and the estimated acceleration data; and
generating the modified output signal comprising the modified operation parameters based on the estimated velocity data, the estimated acceleration data, and the estimated external disturbances.

18. The non-transitory, computer-readable medium of claim 16, wherein the method further comprises:
receiving an input torque value from rear wheels of an autonomous vehicle, the input torque value including a torque coefficient comprising an inverse term of an inertia matrix, wherein the autonomous mechanical system comprises the autonomous vehicle, and wherein the unknown input coefficients comprise at least the torque coefficient;
computing the values based on the torque coefficient, via the dynamic inverter; and
generating the modified output signal comprising the modified operation parameters based on the values of the unknown input coefficients.

19. The non-transitory, computer-readable medium of claim 16, wherein computing the operation parameters for the autonomous mechanical system further comprises:
receiving input values comprising at least a system model of the autonomous mechanical system and historical control move data, by the explicit NMPC framework of the closed-loop control system;
calculating optimum control moves for the autonomous mechanical system, using an optimization cost function over a receding prediction horizon, by the explicit NMPC framework;
computing the operation parameters for the autonomous mechanical system based on the optimum control moves; and
stabilizing the closed-loop control system, by:
performing the optimization cost function using a dual mode control approach, wherein a receding horizon control is used outside a terminal region; and
when states of the system model reach a boundary of the terminal region,
performing the optimization cost function using a virtual linear stabilizing control including a quasi-infinite horizon NMPC scheme using an on-line objective function comprising a finite horizon cost and a terminal cost.

20. The non-transitory, computer-readable medium of claim 16, wherein computing the operation parameters for the autonomous mechanical system further comprises:
receiving input values comprising at least a system model of the autonomous mechanical system and historical control move data, by the explicit NMPC framework of the closed-loop control system;
calculating optimum control moves for the autonomous mechanical system, using an optimization cost function over a receding prediction horizon, by the explicit NMPC framework;
computing the operation parameters for the autonomous mechanical system based on the optimum control moves; and
reducing an intensive computation burden for calculating a nonlinear optimization, by:
estimating output values of continuous-time systems of the system model using Taylor series, to produce approximated output values; and
explicitly calculating the optimum control moves, based on the approximated output values.
